(19) United States
(12) Patent Application Publication
(10) Pub. No.: US 2021/0175717 A1
(43) Pub. Date: Jun. 10, 2021

(54) CONTROLLING MICROGRIDS

(71) Applicant: Siemens Aktiengesellschaft, München (DE)

(72) Inventor: Martin Seydenschwanz, München (DE)

(73) Assignee: Siemens Aktiengesellschaft, München (DE)

(21) Appl. No.: 16/762,683

(22) PCT Filed: Nov. 20, 2017
(86) PCT No.: PCT/EP2017/079780

§ 371 Date: May 8, 2020

(51) Int. Cl. H02J 3/38; G05B 13/02; G06Q 30/02; G06Q 50/06; H02J 3/32

(52) U.S. Cl. CPC H02J 3/381; G05B 13/021; G06Q 30/0202; H02J 2300/20; H02J 3/32; H02J 2203/20; H02J 2300/10; G06Q 50/06

(57) ABSTRACT

A control method for an electrical grid arrangement which includes one or more electric generators and one or more power stores is provided. The grid arrangement is connected or can be connected to a main grid in a controllable manner to draw current. A current withdrawal allocation is defined, which is provided for withdrawal by the grid arrangement from the main grid within a withdrawal time interval. The control method includes determining one or more optimization conditions on the basis of the current withdrawal allocation for a control time interval which is shorter than the withdrawal time interval, and carrying out an optimization of an optimization variable on the basis of the one or more optimization conditions for the control time interval on the basis of time steps having an increment which is shorter than. The method also includes controlling the grid arrangement on the basis of the optimization.

### CROSS-REFERENCE TO RELATED APPLICATIONS

This application claims priority to PCT Application No. PCT/EP2017/079780, having a filing date of Nov. 20, 2017, the entire contents of which are hereby incorporated by reference.

### FIELD OF TECHNOLOGY

The following relates to the control of electricity grid arrangements or microgrids. A control method, a control apparatus and a grid arrangement are in particular described.

### BACKGROUND

Electricity grid arrangements, also called microgrids, may provide electrical energy locally, and are able to operate even without a connection to the power grid or mains grid. A microgrid often comprises components such as one or more power generators and one or more power stores that are controlled by a common controller.

Control methods based on MILPs (mixed-integer linear programs) for microgrids are described for example in “Optimization of On-site Renewable Energy Generation for Industrial Sites”, S. Ruangpattana, D. Klabjan, J. Arinez and S. Biller IEEE Power Systems Conference and Exposition, 2011. In this case, an explanation is given of an optimization approach that anticipatorily actuates the components of the microgrid in relatively short time periods.

In order to balance demand peaks or lack of capacity, they are however often connected to a mains grid in order to be able to draw power. In this case, there are often technical or economic, for instance contractual, conditions that make provision to draw a prescribed amount of power over a particular time period, for instance a monthly contingent. If this amount is exceeded or fallen below by a certain value, the operating efficiency of the microgrid may be restricted, for instance because additional costs or energy losses occur.

### SUMMARY

An aspect relates to optimized control of grid arrangements or microgrids that takes into account an amount of power to be drawn from a mains grid over a relatively long time period in the optimization.

According to embodiments of the invention, what is accordingly provided is a control method for an electricity grid arrangement. The grid arrangement comprises one or more electric power generators and one or more power stores and is connected or able to be connected in a controllable manner to a mains grid in order to draw current. Also defined is a power draw contingent that is intended to be drawn by the grid arrangement from the mains grid in a draw time interval. The control method comprises determining, based on the power draw contingent, one or more optimization conditions for a control time interval that is shorter than the draw time interval. The method furthermore comprises optimizing an optimization variable based on the one or more optimization conditions for the control time interval based on time increments having an increment span that is shorter than the control time interval and actuating the grid arrangement based on the results of the optimization. According to embodiments of the invention, the long-term draw from the mains grid is thus already taken into account in the short-term planning, as a result of which inefficiencies and costs are able to be avoided or reduced. The terms grid arrangement and microgrid are used synonymously below. A time interval may also be referred to as a time period or interval or a duration.

The optimization may be an anticipatory optimization over the control time interval, for instance using a MILP method. The optimization is thereby able to be calculated efficiently and time scales of typical changes, for instance with regard to the load and/or the power generation, are able to be taken into account.

The optimization may be performed on a rolling basis and/or repeatedly. By way of example, the optimization may be reperformed repeatedly at particular intervals, for instance every day or every 12 hours, and/or on a rolling basis such that, after every N completed or elapsed time increments, a new optimization is performed with a control time interval shifted by N time increments, wherein N may in particular be 1. The control time interval may in this case be kept constant with regard to its span, or the span may be changed. In this way, it is possible to respond to short-term changes in operating conditions, for instance a change in weather, suddenly increased power demand, or failure of a component.

The one or more optimization conditions may be based on a demand assumption for the control time interval and/or the draw time interval. The demand assumption may in particular be used as a basis for an anticipatory optimization. A demand assumption may in particular represent a temporal profile of an anticipated draw in the control time interval and/or in the draw time interval, for instance in the form of a cumulative power amount draw or energy draw, or in the form of an absolute draw, for instance per time increment.

The power draw contingent may lie in an acceptance interval. The optimization may in particular be designed to keep the power draw in this acceptance interval over the draw time interval, or at least to minimize or optimize the exceedance or falling below of the interval, possibly taking into account other optimization conditions, inefficiency or costs. The acceptance interval may specify a lower and upper limit of an amount of power that is able to be drawn. If the amount of power that is drawn within the draw time period lies within the acceptance interval, the condition of drawing the power contingent may be deemed to be met. It is in particular then possible to avoid further costs or inefficiencies, for instance in accordance with an agreed rule. A demand assumption may be provided and/or determined in an acceptance range based on the acceptance interval, which acceptance range may relate to a control time interval. There may be multi-level acceptance intervals and/or acceptance ranges, for instance when costs are multi-level.

The optimization may in particular be a cost optimization. Costs may in this case be financial or economic costs or be parameterized as such. As an alternative or in addition, costs may be parameterized for example as energy, current, power, power loss, energy loss, current loss, time loss or delay or the like or relate thereto.

The draw time interval may be at least 2 weeks, or 3 or 4 weeks, or at least or precisely 14 days, or at least or precisely 20 days, or at least or precisely 30 or 31 days, or one month. Such an interval allows long-term planning both for a mains grid operator and for the operator of the microgrid, as a result of which long-term stable operation of the mains grid is in particular guaranteed. Bilateral energy agreements that provide a power contingent therefore normally relate to a corresponding draw time interval.

The control interval may be 48 hours or less, or 24 hours or less, or 12 hours or less. Such an interval may for example be adapted to a battery charging cycle and/or to a consumption cycle and/or a generator cycle. There may be provision that the increment span is 1/12 or less of the control interval, for instance 1/20 or less or 1/24 or less. In some cases, the increment span may be 15 min or more, 30 min or more, 45 min or more, 60 min or more, 90 min or more, or 120 min or more.

What is furthermore provided is a control apparatus for an electricity grid arrangement, wherein the control apparatus is designed to perform and/or to control a control method as described herein. A control apparatus may generally be designed as an integrated circuit and/or comprise an integrated circuit. An integrated circuit may be designed as a processing circuit or processor circuit and/or comprise one or more processors and/or controllers and/or processor cores and/or ASICs (application-specific integrated circuits) and/or FPGAs (field-programmable gate arrays) and/or memories or memory media. Memories or memory media may comprise volatile or non-volatile memories, for instance RAM (random access memory) and/or ROM (read-only memory) and/or flash memories and/or optical memories and/or magnetic memories, etc. A control apparatus may be designed as a computer or computer arrangement or controller arrangement that may have one or more integrated circuits. The control apparatus may have one or more interfaces in order to actuate the microgrid and/or components of the microgrid and/or to receive information, for instance with regard to operating conditions and/or states of the components. The control apparatus may be centralized or distributed, for example on a plurality of computers of a computer arrangement.

What is also described is an electricity grid arrangement that comprises a control apparatus described herein.

Embodiments of the invention may be implemented in the form of a computer program. The program may comprise instructions that prompt a control apparatus on which they are executed to execute and/or to control a method described herein. A memory media combination that may comprise one or more memory and/or carrier media may store the computer program. A memory medium and/or carrier medium may be designed to store and/or to transport instructions and/or data. A computer program may be designed as a control tool.

### BRIEF DESCRIPTION

Some of the embodiments will be described in detail, with reference to the following figures, wherein like designations denote like members, wherein:

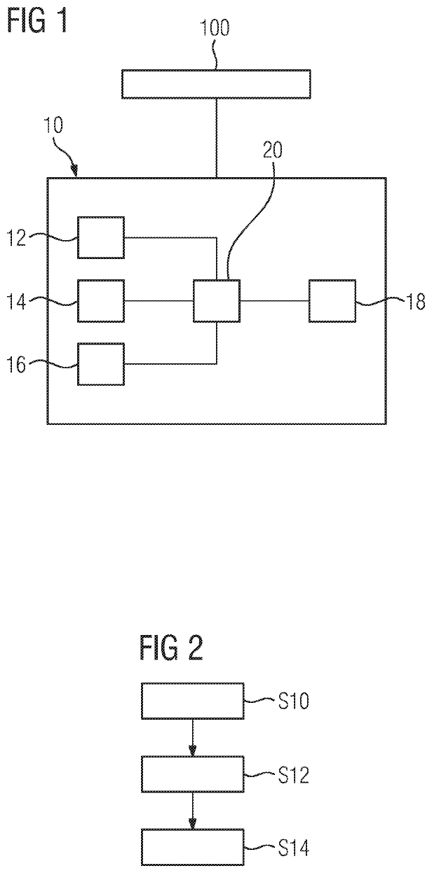

FIG. 1 shows an electricity grid arrangement according to embodiments of the invention;

FIG. 2 shows a method according to embodiments of the invention;

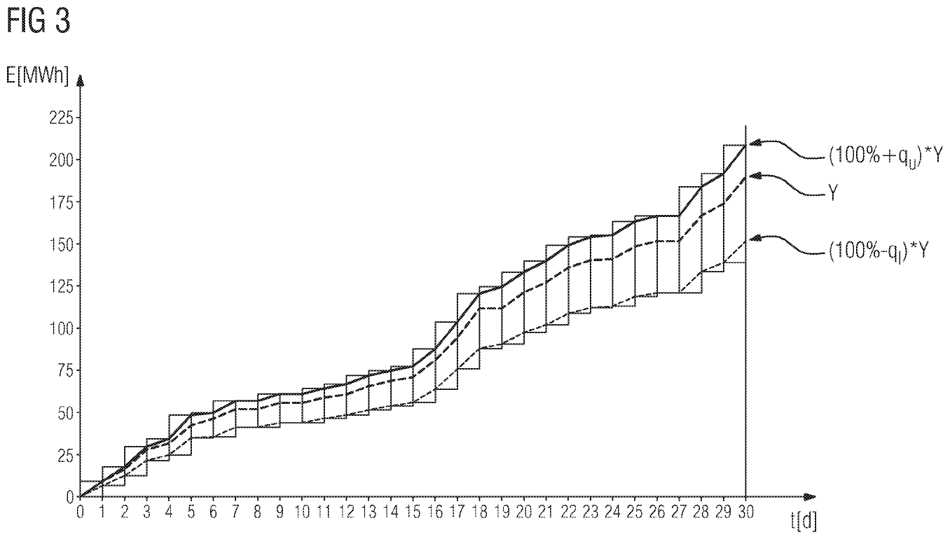

FIG. 3 shows an exemplary draw time interval;

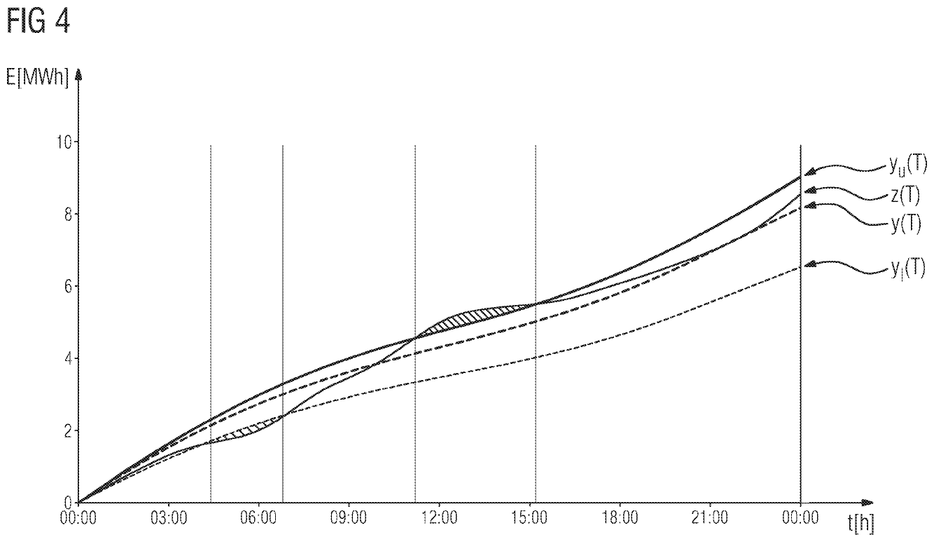

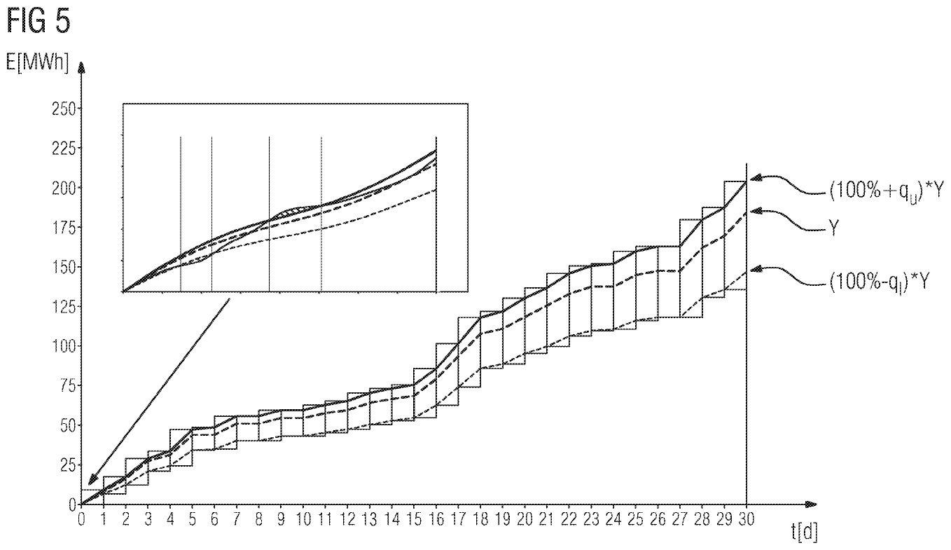

FIG. 4 shows an exemplary control time interval; and

FIG. 5 shows an exemplary draw time interval into which a control time interval is embedded.

### DETAILED DESCRIPTION

FIG. 1 shows an electricity grid arrangement 10 according to embodiments of the invention, which is also referred to as a microgrid. The grid arrangement 10 comprises one or more power generators 12, 14. A power generator may generally be any apparatus able to provide electric power, for instance a combustion generator such as a diesel generator or a solar installation or a wind turbine. The grid arrangement 10 furthermore comprises one or more stores or storage apparatuses 16. A storage apparatus may generally be designed to absorb and to store energy, for instance in the form of electric power, and possibly to output it again. A storage apparatus that outputs power or energy may also act as generator. Examples of storage apparatuses comprise batteries, fuel cells, pump stores, heat stores, etc. Different generators may be of different types, and in the same way different storage apparatuses may be of different types. The components of the grid installation 10 may generally be able to be actuated and operated separately, for instance able to be switched on and off independently of one another. The grid arrangement 10 may furthermore have one or more consumers 18 and/or be connected or able to be connected thereto, for instance for power supply purposes. A control apparatus 20 may be connected to the individual components in order to actuate them. The control apparatus 20 may generally be designed to actuate the components 12, 14, 16 and other components based on a common control method. The electricity grid arrangement 10 may be considered to be an independently operable power grid that may be connected or able to be connected to a mains power grid or mains grid 100, for instance in accordance with the control apparatus 20. The grid arrangement 10 may in particular be connected or able to be connected to the mains grid 100 in order to store power and/or in order to draw power. The mains grid may for example be the public power grid and/or a grid with significantly greater capacity than the grid arrangement 10, for instance a capacity at least 10 times or at least 100 times or at least 1000 times greater. Capacity may in this case for instance be represented in terms of peak power or continuous power or maximum storage capacity or peak current value. Suitable electrical arrangements may be provided for the connection between grid arrangement 10 and mains grid 100 and for the connection of the components of the grid arrangement 10, for instance transformers and/or converters and/or capacitors and/or oscillating circuits and/or other circuits. Mains grid 100 and grid arrangement 10 may have different operators. A power contingent E1 may be defined that, in order to draw from the mains grid 100 by way of the grid arrangement 10, may be provided over a draw time interval T1, such as a month, for instance based on a bilateral agreement between mains grid operator and operator of the grid arrangement. The control apparatus 20 may be designed to execute the control method described herein.

FIG. 2 schematically shows a flowchart of a control method according to embodiments of the invention which may be formed as an algorithm. The method may optionally comprise determining a power contingent E1 and/or draw time interval T and/or acceptance interval and/or a demand assumption, for instance based on an input. The method comprises an operation S10 of determining one or more optimization conditions based on the power draw contingent E1 for a control time interval T2. T2 is shorter than the draw time interval T1. The method furthermore comprises the operation S12 of optimizing an optimization variable based on the one or more optimization conditions for the control time interval T2 based on time increments having an increment span T3. T3 is shorter than T2. The optimization method may in particular comprise a MILP method that is preferably able to be executed iteratively, on a rolling basis or preferably iteratively, repeatedly or on a rolling basis. The method furthermore comprises actuating the grid arrangement based on the optimization as operation S14, for instance for times in accordance with the time increments. The operations may be performed by assigned modules, for instance program modules that may be part of a computer program. The actuation may take place for times that are determined based on the time increments. For instance, for each increment, the assigned increment span may be added to form a sum of increment spans of the preceding increments and an output value or output time, and the actuation may be performed at the determined time.

Optimization conditions may generally be parameters or variables and/or conditions on variables and/or equations and/or inequalities and/or mathematical expressions that are taken into account and/or used in the optimization. An optimization variable may be a variable that is intended to be optimized by the optimization, for instance minimized or maximized. An optimization variable may also be referred to as target variable. An optimization variable may be represented or defined by an expression and/or a formula or equation or parameter and/or be based on one or more optimization conditions and/or be restricted by one or more optimization conditions. A control variable may be a variable that is directly or indirectly controlled or regulated by the method. Control variables may in particular relate to the power output or consumption or power of one or more components, and/or in particular the draw from the mains grid.

In the context of this disclosure, power may be considered to be electric power or electrical energy. An amount of power may be able to be parameterized for instance as current value multiplied by time, or energy or power multiplied by time. A contingent may generally represent an amount of power with regard to a particular time period, such as the draw time interval. The expression “long-term” may relate to the draw time interval, and the expression “short-term” may relate to the control time interval. A draw time interval may in particular be an agreement time horizon or agreement time period, and a control time interval may in particular be a planning time period or planning horizon.

As an example of a power contingent, an amount of energy Y to be drawn, corresponding to the contingent E1, in the agreement time period Tmax, corresponding to the draw time interval T1, at a fixed price c0 per kWh, may be agreed in a bilateral energy agreement between operators of microgrids with a grid connection (for example for industrial installations) and the mains electricity grid operator. There may also be tolerance levels, for example downward differences, that is to say less energy is consumed, and upward differences, that is to say more energy is consumed, in which the price c0 per kWh continues to be guaranteed. The tolerance levels represent an acceptance interval. The following parameters are intended to describe these tolerance levels

qₗ: permissible negative difference (in percent) from the agreed amount of energy in the overall agreement time period Tmax

qᵤ: permissible positive difference (in percent) from the agreed amount of energy in the overall agreement time period Tmax

Thus, if at the end of the agreement time period Tmax, the following holds true for the actual cumulative energy consumption Z:

(100%−qₗ)*Y≤Z≤(100%+qᵤ)*Y

then no additional costs arise. Otherwise, the costs per kWh increase to

cₗ, if Z<(100%−qₗ)*Y

cᵤ, if Z>(100%+qᵤ)*Y.

For cost-optimized operation of the microgrid, this fact is taken into account in the load distribution by actuating the components of the microgrid. Optimization for a microgrid in some variants may have a forecast time period or anticipated horizon T, corresponding to the control time interval T2, of a few hours up to a day. A day is for instance a typical cycle length for battery usage planning. Forecasts for the availability of renewable energy sources and the required power production by other generators in the microgrid may become less reliable for longer planning horizons. The runtimes of the planning programs increase with the length of the planning horizon. MILP-based control tools may for example be restarted on a rolling basis, and have only a limited time to provide results due to the planning during ongoing operation. An excessively long runtime may accordingly have an effect on the control on the time increment level.

In comparison with the agreement runtime Tmax of the bilateral agreements for drawing energy from the grid connection, the described planning horizon T of the control tool is thus significantly shorter. Accordingly, the problem arises of taking into account the energy agreement, which relates only to the cumulative energy draw at the end of the agreement time interval, in the rolling control of the microgrid on the shorter time horizon, in order to minimize operating costs (also including the costs for drawing energy from the grid connection).

First of all, an estimate may be provided on the basis of the agreed amount of energy Y, of the power contingent E1, as demand assumption as a function of time for the expected cumulative energy draw y(t) in the draw time interval, for instance for the time period [O, Tmax] or [Tstart, Tstart+Tmax], wherein Tstart may be a starting time, for instance a start of a month. Such a demand estimation is typically a basis for concluding an energy agreement and should be able to be provided. One example of an alternative estimation may be based on a constant consumption, corresponding to a constant draw from the mains grid, over the agreement period, such that a straight line y(t) results for the cumulative consumption, for which it holds true that y(0)=0 or y(Tstart)=0 and y(Tmax)=Y or y(Tstart+Tmax)=Y. In some implementations, profiles of demand assumptions may be derived from historical data that may for instance represent influencing factors on the energy draw, for instance with regard to the microgrid or one or more components (peak load times, workdays/holidays, etc.).

Based on this expected energy consumption y(t) representing a demand assumption, a lower and upper tolerance level are able to be determined for the cumulative energy draw yₗ(t) and yᵤ(t), respectively, likewise as a function of time, as yₗ(t)=(100%−qₗ)*y(t) and yᵤ(t)=(100%+qᵤ)*y(t). An acceptance range for the demand assumption y(t) is determined through yₗ(t) and yᵤ(t).

FIG. 3 shows an example of a demand assumption with acceptance ranges for an exemplary month containing 30 days as long-term planning. Days of a month are plotted by way of example in the horizontal direction, and a cumulative energy consumption is plotted in the vertical direction. An energy demand estimation for a month and the associated lower/upper tolerance levels (here qₗ=20% and qᵤ=10%) are illustrated by way of example.

An optimization program or method may be implemented based on these parameters. By way of example, an iterative MILP-based approach may be used to integrate bilateral energy agreements (or other power contingents to be drawn in the long term) into programs for the anticipatory, rolling, cost-optimum control of microgrids. The control time interval, the planning horizon [O, T] of the control tool (typically 24 h) may be divided into individual time increments or time intervals tₙ, where N∈{1 . . . N}, where t₀=0 and t_{N}=T. The increment span or duration of the intervals may be the same for all of the time increments, or vary. N may for example be 12 or more, 24 or more, 48 or more or 72 or more.

The following variables and parameters may be used:

tₙ: Beginning of the time interval n; another reference point, for example the middle of the interval, may also be selected instead of the start of the interval;

Δt: Length of the time interval n or increment span

P(tₙ): Power draw from the grid in the time interval n (control variable or one of the control variables)

y(tₙ): Expected cumulative energy consumption until the end of the time interval n

yₗ(tₙ): Lower limit for the cumulative energy consumption until the end of the time interval n

yᵤ(tₙ): Upper limit for the cumulative energy consumption until the end of the time interval n

z(tₙ): Actual cumulative energy consumption until the end of the time interval n

z₀: Actual cumulative energy consumption at the beginning of the planning horizon

Idₗ(tₙ): Indicator variable that indicates whether the actual cumulative energy consumption is lower than the lower limit, that is to say 0, if z(tₙ)≥yₗ(tₙ) and 1, if z(tₙ)<yₗ(tₙ)

Idᵤ(tₙ): Indicator variable that indicates whether the actual cumulative energy consumption is greater than the upper limit, that is to say 0, if z(tₙ)≤yᵤ(tₙ) and 1, if z(tₙ)>y(tₙ)

c₀: Costs per kWh energy consumption (according to energy agreement)

cₗ: Costs per kWh energy consumption, if less than the minimum agreed amount of energy (100%−qₗ)*Y is consumed in the agreement horizon

cᵤ: Costs per kWh energy consumption, if more than the maximum agreed amount of energy (100%+qᵤ)*Y is consumed in the agreement horizon

c(tₙ): Penalty costs per kWh for falling below/exceeding the lower/upper limit for the cumulative energy consumption in the time interval n

M: Large number for conventional MILP technique for switching between the indicator variables Idₗ(tₙ) and Idᵤ(tₙ)

In this example, the energy consumption represents the draw from the mains grid. Variants are conceivable in which the energy consumption represents the entire energy or power consumption of the microgrid, taking into account the draw from the mains grid.

In general, different cost levels may be provided in the case of exceedance and/or falling below, these each increasing for example after an upper or lower limit for the draw is crossed.

Using these variables and parameters, an exemplary mixed-integer linear program (MILP) may then be provided in order to model the behavior of the system and to minimize the additional costs resulting from infringing the conditions of the bilateral energy agreement:

min_{P}Σₙ₌₁^{N}c(tₙ) (1)

z(tₙ)=z₀+Σₖ₌₁ⁿ[P(tₖ)*Δt] (2)

yₗ(tₙ)=(100%−qₗ)*y(tₙ) (3a)

yᵤ(tₙ)=(100%+qᵤ)*y(tₙ) (3b)

M*Idₗ(tₙ)≥y(tₙ)−z(tₙ) (4a)

M*Idᵤ(tₙ)≥z(tₙ)−yᵤ(tₙ) (4b)

c(tₙ)≥0 (5a)

c(tₙ)≥P(tₙ)*Δtₙ*(cₗ−c₀)−M*(1−Idₗ(tₙ)) (5b)

c(tₙ)≥P(tₙ)*Δtₙ*(cᵤ−c₀)−M*(1−Idᵤ(tₙ)) (5c)

This program is controlled via the power points P(tₙ) of the grid connection. The target function (1) is the sum of the penalty costs c(tₙ) per kWh that arise for falling below or exceeding the lower, respectively upper, limit for the cumulative energy consumption in the time intervals n, and should be minimized. The additional condition (2) specifies that the cumulative energy consumption c(tₙ) results from the power draw up to time tₙ (sum as time-discrete approximation of the integral). The relationship between the expected cumulative energy consumption y(tₙ) and the lower, respectively upper, limits yₗ(tₙ) and yᵤ(tₙ) is represented by way of equations (3a) and (3b) for each time increment n. The inequalities (4a) and (4b) ensure that the indicator variables Idₗ(tₙ) and Idᵤ(tₙ) are 1 precisely when the cumulative energy consumption in the time increment n is less than the lower limit yₗ(tₙ) or greater than the upper limit yᵤ(tₙ) (Big-M technique). The inequalities (5a)-(5c) ensure that the additional penalty costs arise only when the indicator variables are active. The costs in the time interval n consist of the product of the energy draw [P(tₙ)*Δtₙ] and the cost difference cₗ−c₀ or cᵤ−c₀. It should be taken into account that the short-term cost contributions cₙ are not necessarily created, even when they occur in the planning horizon. This is because the costs are created only when the sum of differences from the acceptance range of the short-term planning is great enough, when accumulated, to leave the acceptance interval of the long-term planning.

The procedure in the case of short-term daily planning is illustrated in FIG. 4. Hours of a day are plotted by way of example in the horizontal direction, and a cumulative energy consumption is plotted in the vertical direction. FIG. 5 indicates how the short-term planning behaves with respect to the long-term planning from FIG. 3. In FIG. 5, days of a month are plotted by way of example in the horizontal direction, and a cumulative energy consumption is plotted in the vertical direction. FIG. 4 highlights regions in which the acceptance range has been exceeded or fallen below in some time increments.

Instead of one-off daily planning, it is possible to perform rolling planning with regular reoptimization. This is supported by the approach, for instance by shifting the planning horizon/control time interval and/or transferring the current system state, for example the previous cumulative energy consumption z0 in the agreement horizon.

Yet further optimization conditions may be applied for the optimization, these possibly relating for instance to restrictions and costs from the component models of the individual generators in the grid, power balances, reserves, etc. The described embodiments of the invention is able to be integrated very easily into existing and future solutions. By way of example, equation (1) may be expanded with one or more cost contributions per n, or cₙ may be understood to be a vector or tuple of various cost contributions. Additional equations or inequalities with regard to such cost contributions may be added, these for instance possibly representing the operating costs or conditions of individual grid arrangement components.

In comparison with long-term MILP-based planning over the entire time period of energy agreements, for example for designing/expanding microgrids, the described iterative approach for the rolling, cost-optimum control of microgrids taking into consideration the dependencies from energy agreements has one or more advantages. The MILP-based advance planning of the complete agreement time period generates very large optimization problems. Programs for solving such problems (solvers) need far more time for this than those for short-term planning. Due to the runtime and lack of forecasting of the availability of renewable energy sources and the energy demands in the grid, detailed control of the microgrid during operation is susceptible to errors using the approaches involving long-term approaches. According to embodiments of the invention, contingents that are long-term with respect to the planning horizon, for example consisting of bilateral energy agreements, are able to be integrated into detailed, short-term control tools for microgrids.

Short-term, rolling planning with a slowly increasing/moving planning horizon is significantly more precise than planning the entire agreement horizon in advance. The approach according to embodiments of the invention is able to be integrated easily into existing and future MILP-based programs for controlling microgrids. Embodiments of the invention supplements MILP-based programs for the cost-efficient control of microgrids and is very well-suited to complex but runtime-critical applications with planning optimization at runtime.

Embodiments of the invention generally proposes to take into account long-term conditions and/or costs by mapping them using short-term cost approximations and corresponding conditions on a short-term planning horizon.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A control method for an electricity grid arrangement, wherein the grid arrangement comprises one or more electric power generators and one or more power stores, wherein the grid arrangement is connected or able to be connected in a controllable manner to a mains grid in order to draw power, wherein a power draw contingent that is intended to be drawn by the grid arrangement from the mains grid in a draw time interval is further defined, the control method comprising:
determining one or more optimization conditions based on the power draw contingent for a control time interval that is shorter than the draw time interval;
optimizing an optimization variable based on the one or more optimization conditions for the control time interval based on time increments having an increment span that is shorter than the control time interval; and
actuating the grid arrangement based on the optimization.

2. The control method as claimed in claim 1, wherein the optimization is an anticipatory optimization over the control time interval.

3. The control method as claimed in claim 1, wherein the optimization is performed on a rolling basis and/or repeatedly.

4. The control method as claimed in claim 1, wherein the one or more optimization conditions are based on a demand assumption for the control time interval and/or the draw time interval.

5. The control method as claimed in claim 1, wherein the power draw contingent lies in an acceptance interval.

6. The control method as claimed in claim 1, wherein the optimization is a cost optimization.

7. The control method as claimed in claim 1, wherein the draw time interval is at least 2 weeks, or 3 or 4 weeks, or 30 or 31 days or one month.

8. The control method as claimed in claim 1, wherein the control interval is 48 hours or less, or 24 hours or less, or 12 hours or less.

9. A control apparatus for an electricity grid arrangement, wherein the control apparatus is designed to perform the control method as claimed in claim 1.

10. An electricity grid arrangement that comprises the control apparatus as claimed in claim 9.
